(19) United States
(12) Patent Application Publication
(10) Pub. No.: US 2025/0351956 A1
(43) Pub. Date: Nov. 20, 2025

(54) LIGHTWEIGHT MOBILE DEVICE SUPPORT

(71) Applicants: BEN-TIEN LIN, NEW TAIPEI CITY (TW); SHENZHEN MOFT TECHNOLOGY CO., LTD, GUANGDONG PROVINCE (CN)

(72) Inventor: BEN-TIEN LIN, NEW TAIPEI CITY (TW)

(21) Appl. No.: 18/667,111

(22) Filed: May 17, 2024

(51) Int. Cl. A47B 23/04; F16M 11/38

(52) U.S. Cl. CPC A47B 23/044; F16M 11/38

(57) ABSTRACT

A lightweight mobile device support connectible to a mobile device through a coupling mechanism includes: two longitudinal cutting slits formed on both sides of the lightweight mobile device support and extending along both sides respectively; a first transverse flexible part and a second transverse flexible part, both ends of the first transverse flexible part and the second transverse flexible part are connected to the ends of the two longitudinal cutting slits respectively, and at least one flexible subpart is disposed between the first transverse flexible part and the second transverse flexible part; and at least one pair of peripheral transverse flexible parts disposed in the area between the two longitudinal cutting slits and both sides of the lightweight mobile device support.

### BACKGROUND

### Technical Field

The present disclosure relates to supports, and more particularly to a lightweight mobile device support for supporting mobile devices and computer devices.

### Description of Related Art

With the development of mobile devices, such as smart phones, tablet PCs, and e-readers, these mobile devices have become common daily necessities for modern people. As these mobile devices have changed our reading, viewing, and using habits, they have gradually replaced desktop computers and laptops. For the convenience of viewing or operation, the mobile devices are often erected by support stands, and the support stands on the market are mostly metal structure, so it is quite inconvenient to carry. In view of this problem, the present discloser based on years of experience in the related industry to conceive and provide a support stand for mobile devices and computer devices in order to improve the aforementioned drawbacks of the related art.

### SUMMARY

To overcome the aforementioned problem, the present disclosure provides a lightweight mobile device support which can be coupled to a mobile device through a coupling mechanism, and the lightweight mobile device support includes: two longitudinal cutting slits formed on both sides of the lightweight mobile device support and extending along both sides of the lightweight mobile device support respectively; a first transverse flexible part and a second transverse flexible part with both ends coupled to ends of the two longitudinal cutting slits respectively, and comprising at least one flexible subpart disposed between the first transverse flexible part and the second transverse flexible part; and at least one pair of peripheral transverse flexible parts disposed in an area between the two longitudinal cutting slits and both sides of the lightweight mobile device support.

In some embodiments, the lightweight mobile device support only includes one flexible subpart, a first part disposed between the first transverse flexible part and the flexible subpart, a second part disposed between the flexible subpart and the second transverse flexible par, and a third part disposed between the second transverse flexible part and a side of the lightweight mobile device support.

In some embodiments, the lightweight mobile device support only includes a pair of peripheral transverse flexible parts. The pair of peripheral transverse flexible parts are parallel to the first transverse flexible part and the flexible subpart respectively, and the pair of peripheral transverse flexible parts are adjacent to the flexible subpart. The first part and the second part can attach and abut each other by bending the first transverse flexible part, the second transverse flexible part, and the flexible subpart to define a bending state; or the second part can attach the first transverse flexible part, the second transverse flexible part, and the flexible subpart by bending the third part to define a bending state. When the first part and the second part abut each other, the first part or the second part and the third part intersect each other.

In some embodiments, the lightweight mobile device support further includes a plurality of depression areas disposed on a side of the lightweight mobile device support, and a plurality of couplers disposed on a side of the mobile device, wherein the size of the plurality of depression areas corresponds to the size of the plurality of couplers. The plurality of depression areas and the plurality of couplers are ferromagnetic, the plurality of depression areas and the plurality of couplers are coupled to each other by the ferromagnetism and the corresponding sizes of the plurality of depression areas and the plurality of couplers, so as to couple the lightweight mobile device support with the mobile device. In some embodiments, the second part has the plurality of depression areas.

In some embodiments, a side of the lightweight mobile device support is provided with an adhesive area provided for fixing the lightweight mobile device support to a side of the mobile device and bending the first part, the second part, and the third part relative to a side of the mobile device.

In some embodiments, when the lightweight mobile device support is coupled to the mobile device and situated in the bending state, one side of the flexible subpart or the third part abuts a plane to erect the mobile device at an angle from the plane; or when the lightweight mobile device support is coupled to the mobile device and situated in the bending state, one side of the flexible subpart and the third part abuts a plane to erect the mobile device at an angle from the plane.

In the above-mentioned embodiment, the mobile device can be supported at different heights and angles through the design of a folding line, which can be adjusted to match the ambient light and the user's viewing angle, and to provide a more convenient viewing.

### BRIEF DESCRIPTION OF THE DRAWINGS

FIG. 1 is a schematic view of a lightweight mobile device support of this disclosure;

FIG. 2 is a schematic view of a lightweight mobile device support of this disclosure, after bending;

FIG. 3 is another schematic view of a lightweight mobile device support of this disclosure, after bending;

FIG. 4 is a side view of a lightweight mobile device support of this disclosure, after bending;

FIG. 5 is a schematic view showing a using status of a lightweight mobile device support of this disclosure, after bending;

FIG. 6 is another schematic view of a lightweight mobile device support of this disclosure, after bending;

FIG. 7 is another side view of a lightweight mobile device support of this disclosure, after bending;

FIG. 8 is another schematic view showing a using status of a lightweight mobile device support of this disclosure, after bending;

FIG. 9 is a schematic view showing a depression area and a coupler of this disclosure;

FIG. 10 is another schematic view showing a depression area and a coupler of this disclosure;

FIG. 11 is another schematic view showing a depression area and a coupler of this disclosure; and

FIG. 12 is another schematic view showing a using status of a lightweight mobile device support of this disclosure, after bending.

### DESCRIPTION OF THE EMBODIMENTS

The technical characteristics of the present disclosure will become apparent in the following detailed description of the preferred embodiment with reference to the accompanying drawings.

Although the terms “first”, “second”, and “third” may be used herein to describe various components, parts, regions, or sections, these components, parts, regions, and/or sections should not be limited by the terms. The terms are used only to distinguish one component, part, region, or portion from another component, part, region, layer, or portion. Therefore, the following “first . . . ” may be interpreted as “second . . . ” or “third . . . ” without departing from the teachings of this disclosure.

Although the terms “longitudinal” and “transverse” are used herein to describe the relative positions or orientations of various components, the present disclosure is not limited to any single position or orientation, and therefore the interpretation of the terms “longitudinal” and “transverse” is interchangeable without specific restrictions.

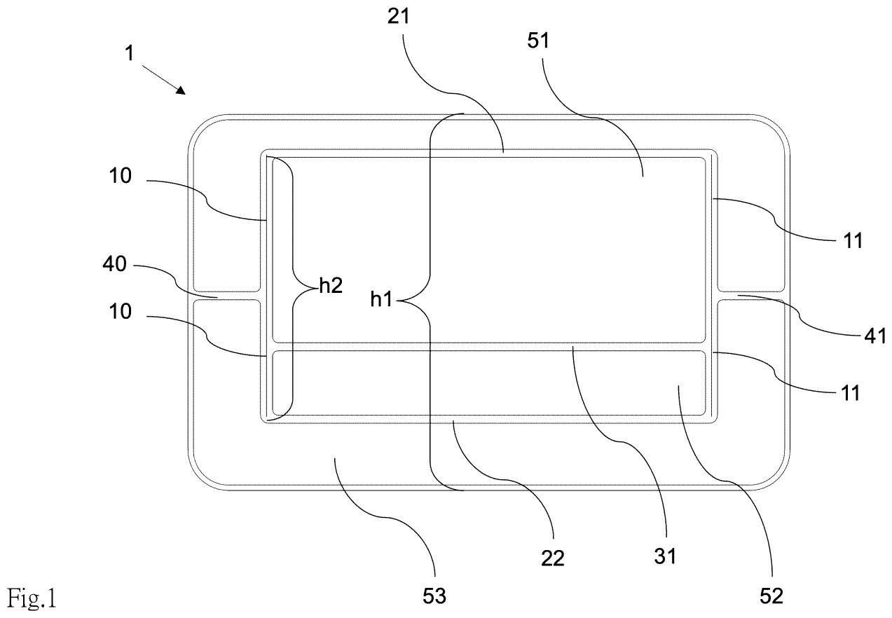

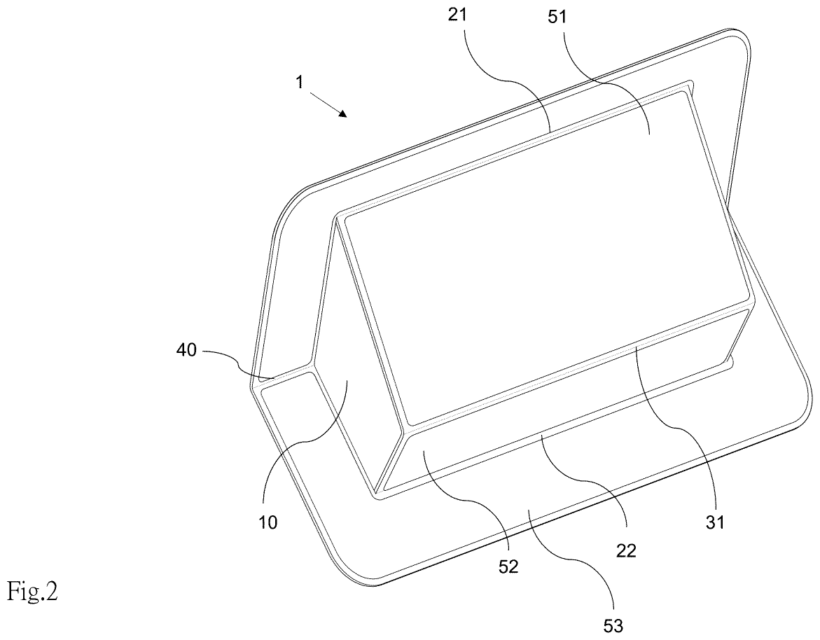

The present disclosure provides a lightweight mobile device support which can be coupled to a mobile device through a coupling mechanism. After folding, the lightweight mobile device support allows the mobile device to stand on a plane at an angle, which changes the user's viewing or operating angle of the mobile device, thus enhancing comfort and convenience. With reference to FIGS. 1 and 2, the lightweight mobile device support 1 is basically a sheet body, which includes: two longitudinal cutting slits 10, 11, disposed on both sides of the lightweight mobile device support 1 and extending along both sides of the lightweight mobile device support respectively. The longitudinal cutting slit 10, 11 is formed by cutting the a part of the lightweight mobile device support 1 by a cutting device during manufacturing and provided for facilitating the folding of the lightweight mobile device support 1. The lightweight mobile device support 1 further includes a first transverse flexible part 21 and a second transverse flexible part 22, the first transverse flexible part 21 and the second transverse flexible part 22 have a predetermined length and both ends thereof are connected to ends of the two longitudinal cutting slits 10, 11 respectively, and at least one flexible subpart 31 is disposed between the first transverse flexible part 21 and the second transverse flexible part 22. The lightweight mobile device support 1 further includes at least one pair of peripheral transverse flexible parts 40, 41 disposed in an area between the two longitudinal cutting slits 10, 11 and both sides of the lightweight mobile device support.

With reference to FIGS. 1 and 2, the lightweight mobile device support 1 of the following embodiment only includes a flexible subpart 31, but the present disclosure is not limited by this embodiment. In some embodiments, a first part 51 is included between the first transverse flexible part 21 and the flexible subpart 31, a second part 52 is included between the flexible subpart 31 and the second transverse flexible part 22, and a third part 53 is included between the second transverse flexible part 22 and a side of the lightweight mobile device support 1.

With reference to FIGS. 1 and 2, the lightweight mobile device support 1 only includes a pair of peripheral transverse flexible parts 40, 41 in accordance with some embodiments. In the following embodiment, the lightweight mobile device support 1 only including a pair of peripheral transverse flexible parts 40, 41 is used for illustrating the present disclosure, but the present disclosure is not limited to this embodiment. The pair of peripheral transverse flexible parts 40, 41 are parallel to the first transverse flexible part 21 and the flexible subpart 31 respectively, and the peripheral transverse flexible part 40, 41 is relatively more adjacent to the flexible subpart 31. It is noteworthy that the relative position of each flexible part in the present disclosure is particularly important, because even if the flexible parts are the same, different relative positions of the flexible parts will lead to a change in the folded form.

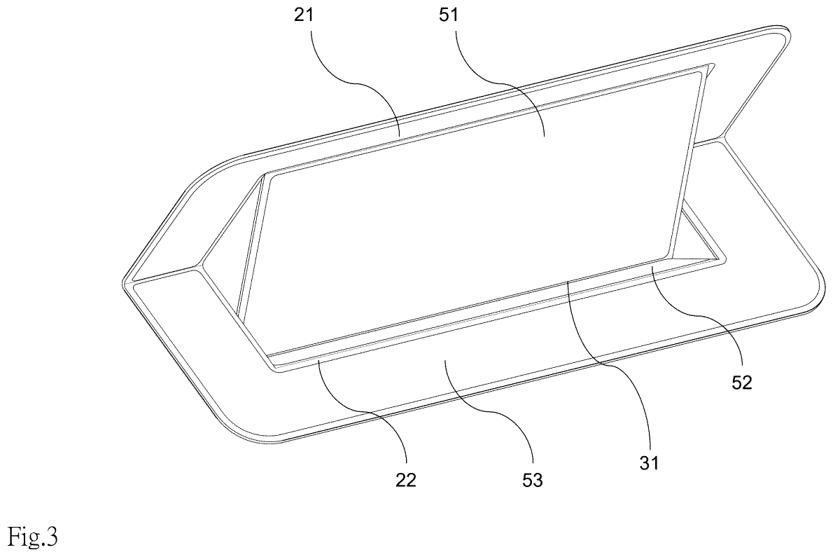

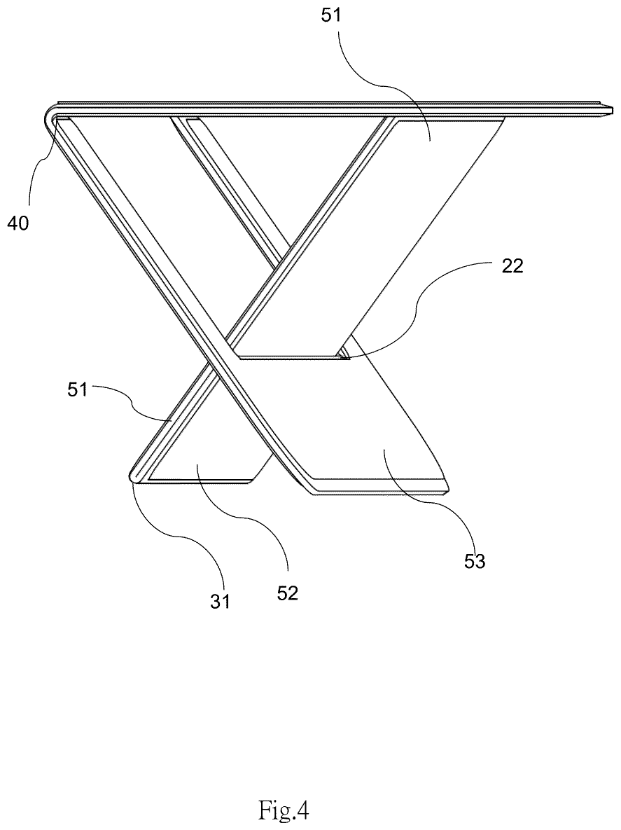

With reference to FIGS. 3 to 5, during folding, the first part 51 and the second part 52 can attach and abut each other by bending the first transverse flexible part 21, the second transverse flexible part 22, and the flexible subpart 31 to define a bending state. In FIG. 4 which shows the side view of the folded structure of the present disclosure, when the first part 51 and the second part 52 abut each other, the first part 51 or the second part 52 and the third part 53 intersect each other.

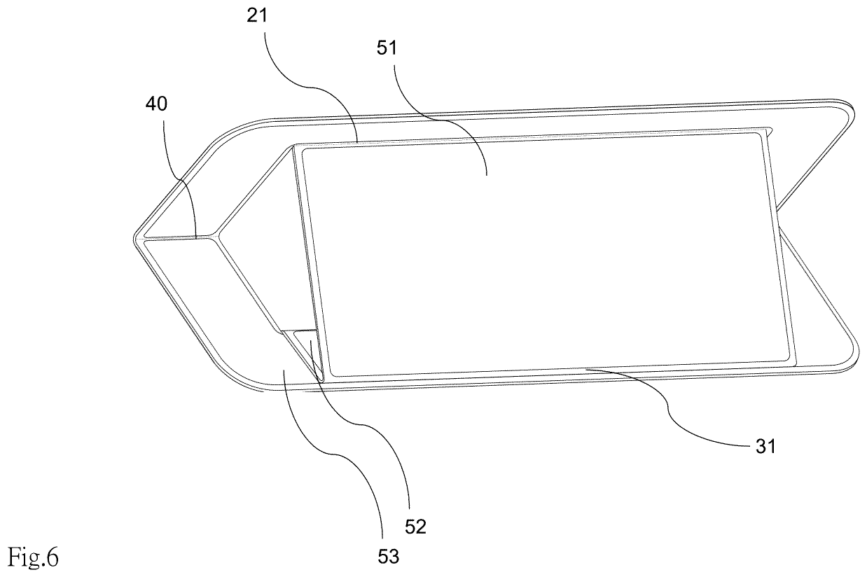

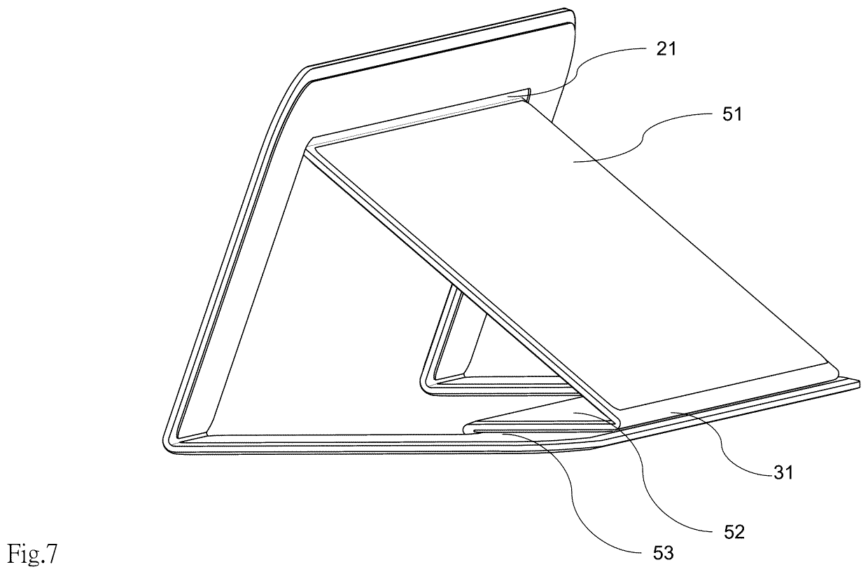

With reference to FIGS. 6 to 8, in another bending state, the second part 52 can attach and abut the third part 53 to define a bending state by bending the first transverse flexible part 21, the second transverse flexible part 22, and the flexible subpart 31.

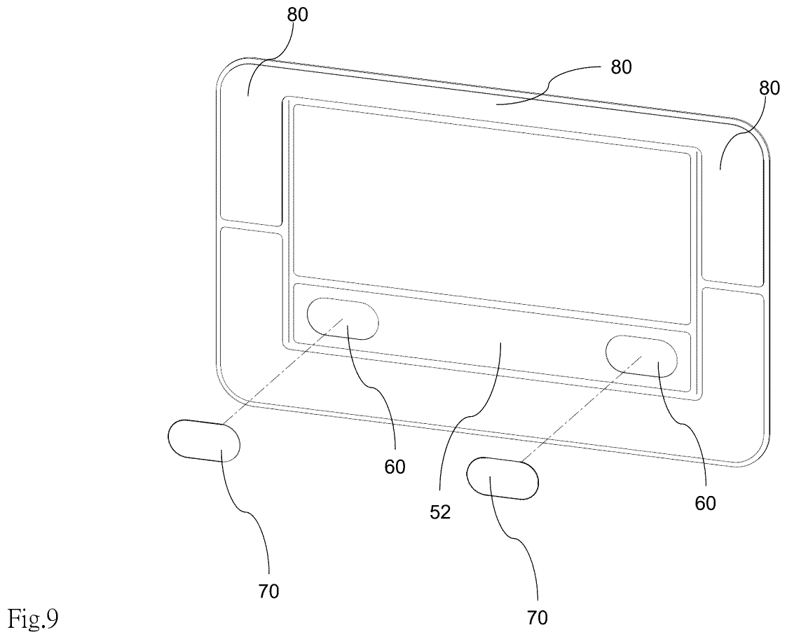

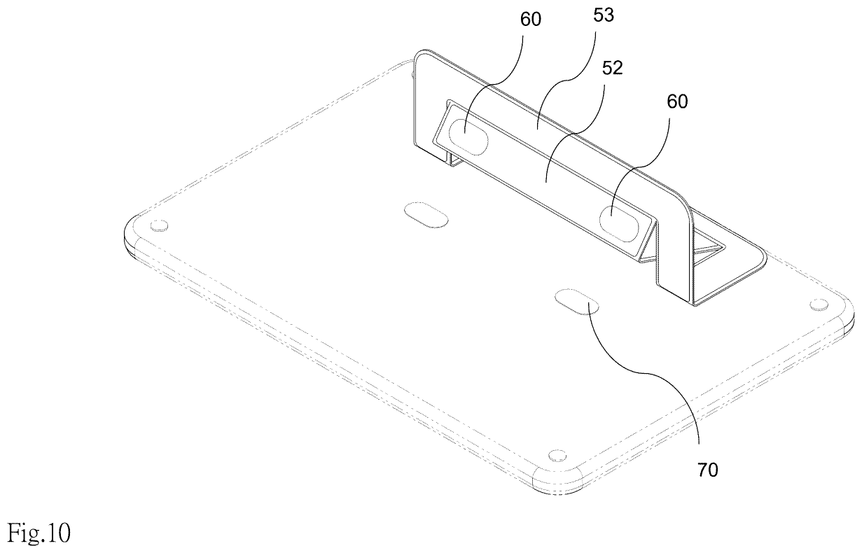

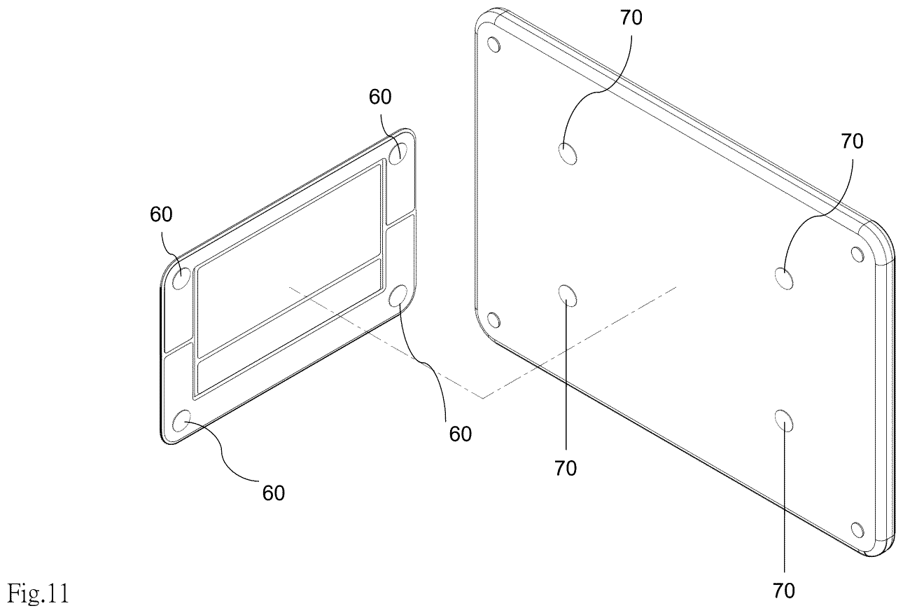

With reference to FIGS. 9 to 11, another feature of the present disclosure is that a side of the lightweight mobile device support 1 is provided with a plurality of depression areas 60. Since the lightweight mobile device support 1 has a predetermined thickness, the plurality of depression areas 60 are areas of the lightweight mobile device support 1 with a smaller thickness. In addition, the present disclosure further includes a plurality of couplers 70 disposed on a side of the mobile device, wherein the size of the plurality of depression areas 60 corresponds to the size of the plurality of couplers 70, specifically the plurality of depression areas 60 and the plurality of couplers 70 correspond to each other in terms of size or thickness. In some embodiments, the plurality of depression areas 60 and the plurality of couplers 70 are ferromagnetic, the plurality of depression areas 60 and the plurality of couplers 70 fit together through ferromagnetism, and the corresponding sizes of the plurality of depression areas 60 and the plurality of couplers 70, so as to couple the lightweight mobile device support 1 with the mobile device without the problem of sliding. In some embodiments, the plurality of depression areas 60 can be arranged at the second part 52. In some other embodiments, the plurality of depression areas 60 can also be arranged at the third part 53. In this way, the first part 51, the second part 52, and the third part 53 can be bent relative to a side of the mobile device, and users can install/remove the lightweight mobile device support 1 to/from the mobile device for convenience of use.

In some embodiments, a side of the lightweight mobile device support 1 is provided with an adhesive area 80, so that the lightweight mobile device support 1 can be fixed to a side of the mobile device through the adhesive area 80, so as to bend the first part 51, the second part 52, and the third part 53 relative to a side of the mobile device.

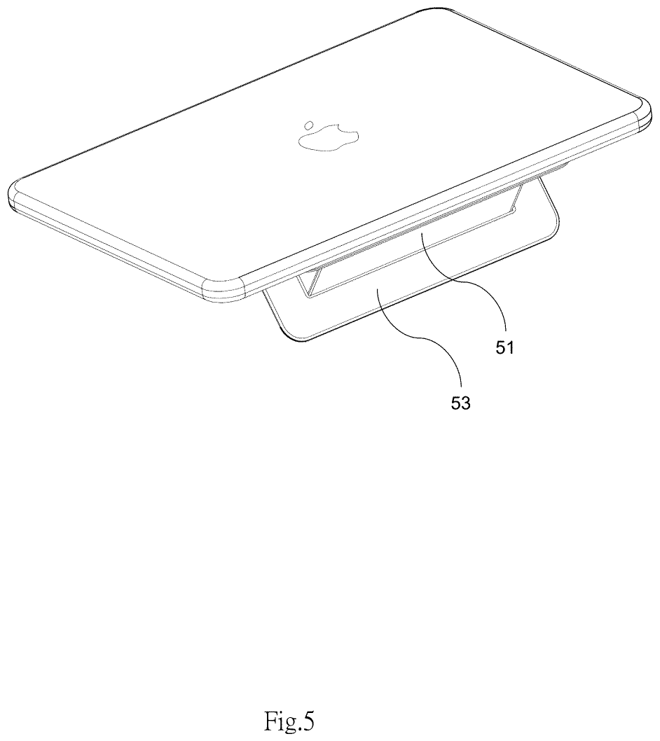

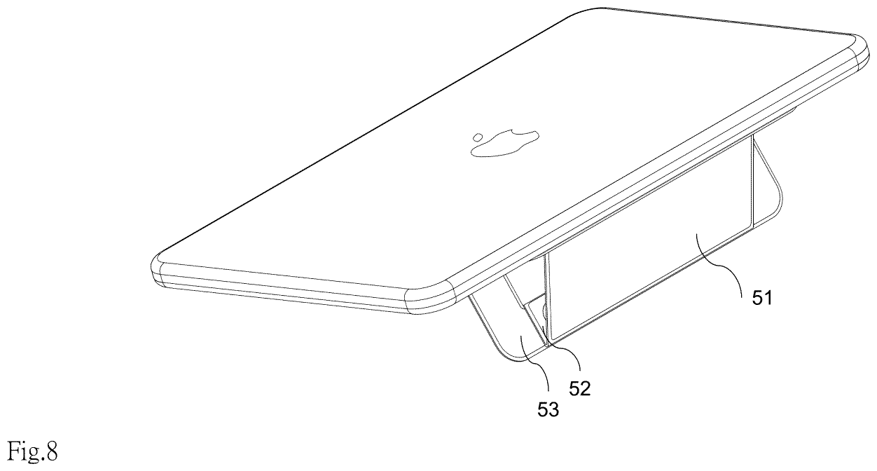

With reference to FIGS. 5 and 8 for the schematic views showing the using status of the present disclosure, in some embodiments, when the lightweight mobile device support 1 is coupled to the mobile device and situated in one of the bending states, only a side of the flexible subpart 31 or the third part 53 attaches and abuts a plane to erect the mobile device at an angle from the plane; or in another bending state, when the lightweight mobile device support 1 is coupled to the mobile device and situated in the bending state, a side of the flexible subpart 31 and the third part 53 attaches and abuts a plane to erect the mobile device at an angle from the plane. It can produce different standing angles, and users can adjust the way of bending according to their preferences to achieve the desired angle of use.

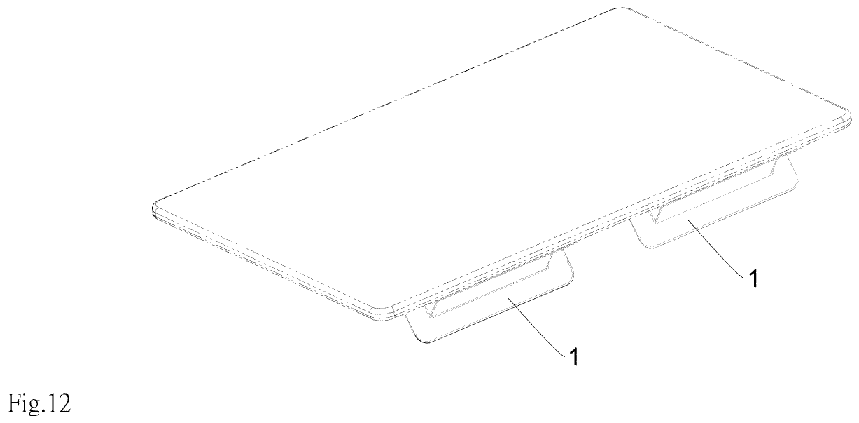

With reference to FIG. 12, the plurality of lightweight mobile device supports 1 can be installed behind the mobile device in accordance with some embodiments.

The present invention can be applied to laptop computers or mobile devices to create adjustable height for the user of the laptop computers. With reference to FIGS. 6-8, and To ensure the ventilation and heat dissipation of the laptop computer or mobile device from the ventilation openings of the laptop computers or mobile devices, it is important that first part 51 needs to be sufficiently apart from the surface of the laptop computer or the mobile device when the present invention is in the bend state. The distance between the first part 51 and the laptop computers or mobile devices is affected by the ratio between the height of the lightweight mobile device support h1 and the length of any of the two longitudinal cutting slits h2. Therefore, with reference to FIG. 1, the ratio between the height of the lightweight mobile device support h1 and the length of any of the two longitudinal cutting slits h2 needs to satisfy a critical ratio (i.e., h1/h2). In an embodiment, the ratio is preferably between 1.16-2. In other embodiment, the ratio is even more preferably between 1.21-1.75.

While the present disclosure is described in some detail hereinbelow with reference to certain illustrated embodiments, it is to be understood that there is no intent to limit the disclosure to those embodiments. On the contrary, the aim is to cover all modifications, alternatives and equivalents falling within the spirit and scope of the disclosure as defined by the appended claims.

What is claimed is:

1. A lightweight mobile device support, coupled to a mobile device through a coupling mechanism, comprising:
two longitudinal cutting slits, formed on both sides of the lightweight mobile device support and extending along both sides of the lightweight mobile device support respectively;
a first transverse flexible part and a second transverse flexible part, with both ends coupled to ends of the two longitudinal cutting slits respectively, and comprising at least one flexible subpart disposed between the first transverse flexible part and the second transverse flexible part; and
at least one pair of peripheral transverse flexible parts, disposed in an area between the two longitudinal cutting slits and both sides of the lightweight mobile device support,
wherein a ratio between a height of the lightweight mobile device support and a length of any of the two longitudinal cutting slits needs to satisfy a critical ratio.

2. The lightweight mobile device support according to claim 1, wherein the ratio is between 1.16-2.

3. The lightweight mobile device support according to claim 1, wherein the ratio is between 1.21-1.75.

4. The lightweight mobile device support according to claim 1, wherein the lightweight mobile device support only comprises one flexible subpart, a first part disposed between the first transverse flexible part and the flexible subpart, a second part disposed between the flexible subpart and the second transverse flexible par, and a third part disposed between the second transverse flexible part and a side of the lightweight mobile device support.

5. The lightweight mobile device support according to claim 1, wherein the lightweight mobile device support only comprises a pair of peripheral transverse flexible parts.

6. The lightweight mobile device support according to claim 4, wherein the first part and the second part attach and abut each other by bending the first transverse flexible part, the second transverse flexible part, and the flexible subpart to define a bending state.

7. The lightweight mobile device support according to claim 4, wherein the second part attaches and abuts the third part by bending the first transverse flexible part, the second transverse flexible part, and the flexible subpart to define a bending state.

8. The lightweight mobile device support according to claim 4, wherein the pair of peripheral transverse flexible parts are parallel to the first transverse flexible part and the flexible subpart respectively and the pair of peripheral transverse flexible parts are adjacent to the flexible subpart.

9. The lightweight mobile device support according to claim 6, wherein when the first part and the second part abut each other, the first part or the second part and the third part intersect each other.

10. The lightweight mobile device support according to claim 4, further comprising a plurality of depression areas defined on a side of the lightweight mobile device support, and a plurality of couplers disposed on a side of the mobile device, wherein the size of the plurality of depression areas corresponds to the size of the plurality of couplers.

11. The lightweight mobile device support according to claim 10, wherein the plurality of depression areas and the plurality of couplers are ferromagnetic, the plurality of depression areas and the plurality of couplers fit together through ferromagnetism, and the corresponding sizes of the plurality of depression areas and the plurality of couplers, so as to couple the lightweight mobile device support with the mobile device.

12. The lightweight mobile device support according to claim 11, wherein the second part or the third part is provided with the plurality of depression areas.

13. The lightweight mobile device support according to claim 4, wherein the lightweight mobile device support comprises an adhesive area defined on a side thereof, and provided for fixing the lightweight mobile device support to a side of the mobile device and bending the first part, the second part, and the third part relative to a side of the mobile device.

14. The lightweight mobile device support according to claim 6, wherein when the lightweight mobile device support is coupled to the mobile device and situated in the bending state, only a side of the flexible subpart or the third part abuts a plane to erect the mobile device at an angle from the plane.

15. The lightweight mobile device support according to claim 7, wherein when the lightweight mobile device support is coupled to the mobile device and situated in the bending state, only a side of the flexible subpart or the third part abuts a plane to erect the mobile device at an angle from the plane.

16. The lightweight mobile device support according to claim 6, wherein when the lightweight mobile device support is coupled to the mobile device and situated in the bending state, a side of the flexible subpart and the third part abuts a plane to erect the mobile device at an angle from the plane.

17. The lightweight mobile device support according to claim 7, wherein when the lightweight mobile device support is coupled to the mobile device and situated in the bending state, a side of the flexible subpart and the third part abuts a plane to erect the mobile device at an angle from the plane.
